(19) United States
(12) Patent Application Publication
(10) Pub. No.: US 2012/0019491 A1
(43) Pub. Date: Jan. 26, 2012

(54) FLAT DISPLAY APPARATUS

(75) Inventor: Kai-Cheng Chuang, Hsinchu (TW)

(73) Assignee: E Ink Holdings Inc., Hsinchu City (TW)

(21) Appl. No.: 13/007,223

(22) Filed: Jan. 14, 2011

(30) Foreign Application Priority Data
Jul. 21, 2010 (TW) 099123977

(51) Int. Cl. G09G 5/00

(52) U.S. Cl. 345/205; 345/3.1

(57) ABSTRACT

A flat display apparatus comprises a first display screen and a second display screen. The first display screen is a particle-based display screen, and the second display screen is a liquid-based display screen.

### FIELD OF THE INVENTION

The present invention relates to the display field, and more particularly to a flat display apparatus.

### BACKGROUND OF THE INVENTION

With the rapid development of the electronic technology, various portable electronic products, such as personal digital assistant (PDA), e-book, mobile phone, etc., greatly enrich the consumption market and satisfy various works and amusement needs of human. In these portable electronic products, flat display apparatus is an important component for displaying data, characters and patterns. However, since the flat display apparatus is a device that consumes large power, these portable electronic products must be often charged. Thus, the portable character of the portable electronic products is decreased.

Therefore, some portable electronic products such as e-book readers are changed to adopt a particle-based display screen such as an electrophoretic display screen. Since the electrophoretic display screen has an image-memory character and only consumes power when it updates the display image, the electrophoretic display can greatly decrease power consumption. However, the particle-based display screen also has some disadvantageous. For example, the response speed of the particle-based display screen is low, and the color degree of the particle-based display screen is bad.

### SUMMARY OF THE INVENTION

The present invention relates to a flat display apparatus, which allows a user to select a display screen with little power consumption or a display screen with high response speed and good color degree.

The present invention provides a flat display apparatus, which comprises a first display screen and a second display screen. The first display screen is a particle-based display screen, and the second display screen is a liquid-based display screen.

In an exemplary embodiment of the present invention, the particle-based display screen is an electrophoretic display screen, and the liquid-based display screen is an electrowetting display screen.

In an exemplary embodiment of the present invention, the flat display apparatus further comprises a gate driver, and the gate driver is electrically coupled to the first display screen and the second display screen.

In an exemplary embodiment of the present invention, the flat display apparatus further comprises a first gate driver and a second gate driver. The first gate driver and the second gate driver are electrically coupled to the first display screen and the second display screen respectively.

In an exemplary embodiment of the present invention, the flat display apparatus further comprises a source driver. The source driver is electrically coupled to the first display screen and the second display screen.

In an exemplary embodiment of the present invention, the flat display apparatus further comprises a first source driver and a second source driver. The first source driver and the second source driver are electrically coupled to the first display screen and the second display screen respectively.

The flat display apparatus of the present invention comprises not only the first display screen implemented by a particle-based display screen but also the second display screen implemented by a liquid-based display screen. Thus, a user can select the particle-based display screen with little power consumption or the liquid-based display screen with high response speed and good color degree.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a flat display apparatus in accordance with an exemplary embodiment of the present invention.

FIG. 2 is a schematic view of an implement manner of a flat display apparatus in accordance with an exemplary embodiment of the present invention.

FIG. 3 is a schematic view of an implement manner of a flat display apparatus in accordance with another exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

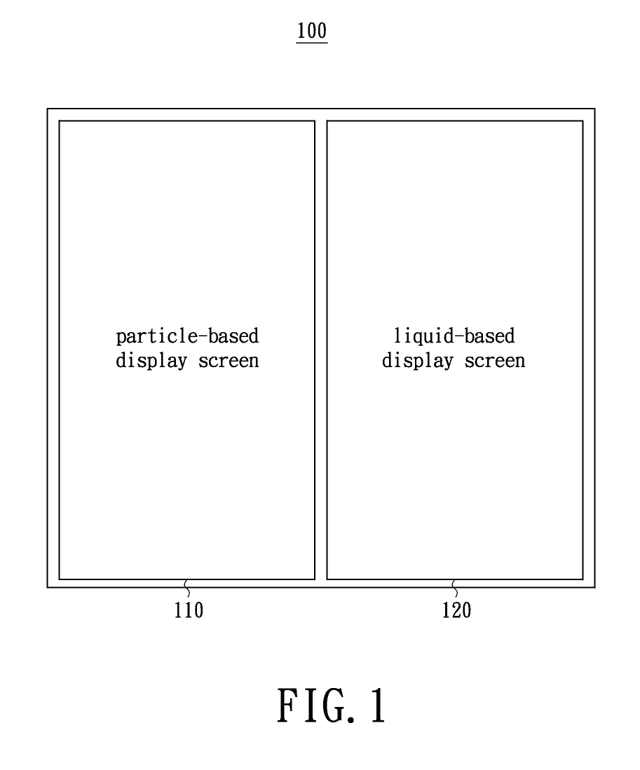

Refer to FIG. 1, a schematic view of a flat display apparatus in accordance with an exemplary embodiment of the present invention is shown. As shown in FIG. 1, the flat display apparatus 100 comprises a first display screen 110 and a second display screen 120. The first display screen 110 is a particle-based display screen such as an electrophoretic display screen, and the second display screen 120 is a liquid-based display screen such as an electrowetting display screen.

Since the particle-based display screen such as the electrophoretic display screen has a bistable character, it consumes power only when updating images. However, the particle-based display screen has bad response speed and bad color degree. The liquid-based display screen such as the electrowetting display screen has high response speed and good color degree, but it consumes large power. The flat display apparatus 100 of the present invention comprises not only the first display screen 110 implemented by a particle-based display screen but also the second display screen 120 implemented by a liquid-based display screen. Thus, a user can select the particle-based display screen with little power consumption or the liquid-based display screen with high response speed and good color degree.

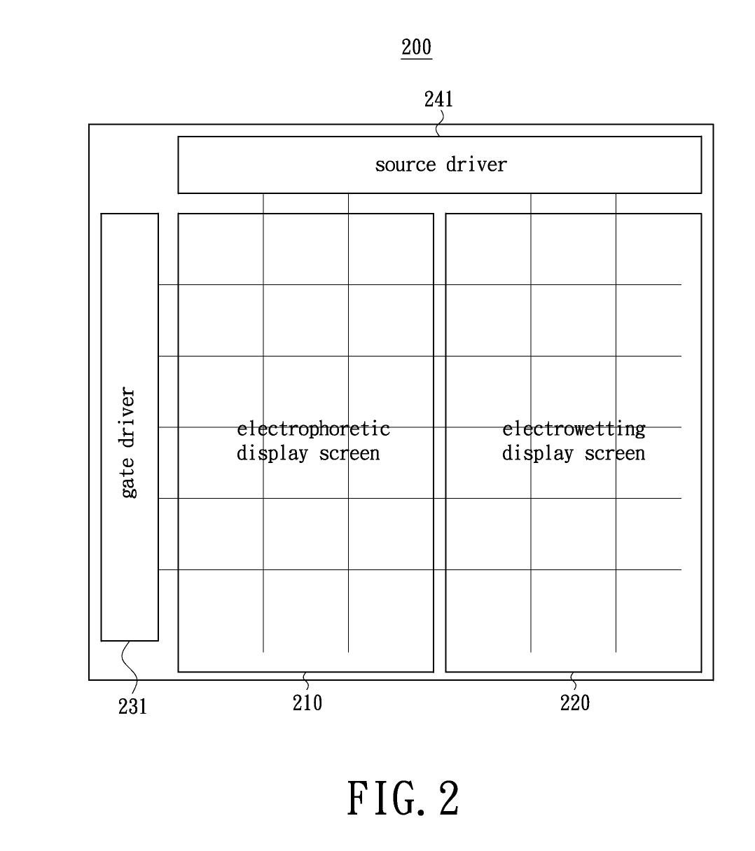

Refer to FIG. 2, a schematic view of an implement manner of a flat display apparatus in accordance with an exemplary embodiment of the present invention is shown. As shown in FIG. 2, the flat display apparatus 200 of the exemplary embodiment comprises a first display screen 210 implemented by a particle-based display screen, a second display screen 220 implemented by a liquid-based display screen, a gate driver 231 and a source driver 241. The gate driver 231 is electrically coupled to the first display screen 210 and the second display screen 220, so as to control the on/off states of the pixels (not shown) of the first display screen 210 and the second display screen 220. The source driver 241 is also electrically coupled to the first display screen 210 and the second display screen 220, so as to provide related display data to the pixels of the first display screen 210 and the second display screen 220.

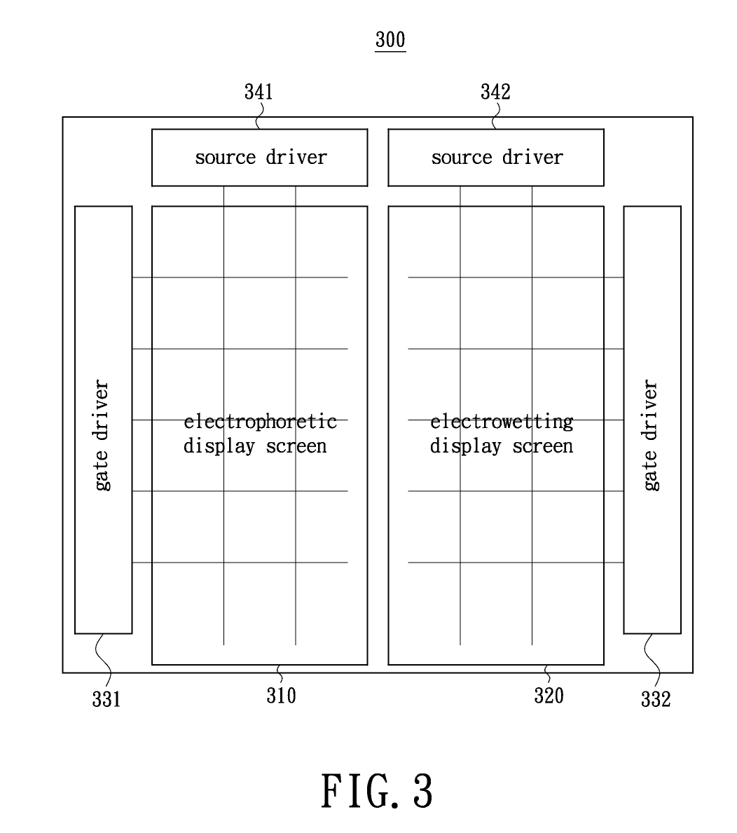

Refer to FIG. 3, a schematic view of an implement manner of a flat display apparatus in accordance with another exemplary embodiment of the present invention. As shown in FIG. 3, the flat display apparatus 300 of the exemplary embodiment comprises a first display screen 310 implemented by a particle-based display screen, a second display screen 320 implemented by a liquid-based display screen, a gate driver 331, a gate driver 332, a source driver 341 and a source driver 342. The gate driver 331 and the source driver 341 are both electrically coupled to the first display screen 310, and the gate driver 332 and the source driver 342 are both electrically coupled to the second display screen 320.

In other words, the first display screen and the second display screen of the present invention may employ the same gate driver to control the on/off states of the pixels thereof or employ two different gate drivers to control the on/off states of the pixels thereof respectively. Similarly, the first display screen and the second display screen may employ the same source driver to provide the display data or employ two different source drivers to provide the display data. Certainly, it is understood for persons skilled in the art that the flat display apparatus of the present invention may employ one gate driver and two source drivers to control the first display screen and the second display screen or employ two gate drivers and one source driver to control the first display screen and the second display screen.

In summary, the flat display apparatus of the present invention comprises not only the first display screen implemented by a particle-based display screen but also the second display screen implemented by a liquid-based display screen. Thus, a user can select the particle-based display screen with little power consumption or the liquid-based display screen with high response speed and good color degree.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flat display apparatus, comprising:
a first display screen; and
a second display screen;
wherein the first display screen is a particle-based display screen, and the second display screen is a liquid-based display screen.

2. The flat display apparatus according to claim 1, wherein the particle-based display screen is an electrophoretic display screen, and the liquid-based display screen is an electrowetting display screen.

3. The flat display apparatus according to claim 1, further comprising a gate driver, wherein the gate driver is electrically coupled to the first display screen and the second display screen.

4. The flat display apparatus according to claim 1, further comprising a first gate driver and a second gate driver, wherein the first gate driver and the second gate driver are electrically coupled to the first display screen and the second display screen respectively.

5. The flat display apparatus according to claim 1, further comprising a source driver, wherein the source driver is electrically coupled to the first display screen and the second display screen.

6. The flat display apparatus according to claim 1, further comprising a first source driver and a second source driver, wherein the first source driver and the second source driver are electrically coupled to the first display screen and the second display screen respectively.
